(19) United States
(12) Patent Application Publication
(10) Pub. No.: US 2017/0093971 A1
(43) Pub. Date: Mar. 30, 2017

(54) SYSTEM AND METHOD FOR ORCHESTRATING REPLICATED COMPONENTS IN A REPLICATED CLOUD BASED COMPUTING ENVIRONMENT

(71) Applicant: CLOUDENDURE LTD., Ramat Gan (IL)

(72) Inventors: Leonid Feinberg, Ramat HaSharon (IL); Ofir EHRLICH, Netanya (IL); Ophir SETTER, Ramat Gan (IL); Roman ZEYDE, Afula (IL); Sigal Weiner, Holon (IL)

(73) Assignee: CLOUDENDURE LTD., RAMAT GAN (IL)

(21) Appl. No.: 14/870,652

(22) Filed: Sep. 30, 2015

(51) Int. Cl. H04L 29/08; G06F 9/44

(52) U.S. Cl. CPC H04L 67/1095; H04L 67/1097; G06F 9/4416

(57) ABSTRACT

A system and method for orchestrating replicated components in a replicated cloud-computing environment. The method comprises: receiving computer data from a first original component in a first cloud-computing environment; allocating a first replicated component in a second cloud-computing environment, the first replicated component corresponding to the first original component; initializing a loader machine in the second cloud-computing environment; replicating the computer data to the loader machine; initializing the computer data as at least a data disk of the loader machine; configuring the loader machine with a first group of attributes of the replicated computer data, the first group of attributes allowing the first replicated component to initialize a boot process in the second computing environment; providing the replicated computer data to the first replicated component; and causing initialization of a boot process of the first replicated component in the second cloud-computing environment using the first group of attributes.

### TECHNICAL FIELD

The disclosure generally relates to replicating machines from one computing environment to another, and particularly to initializing a replicated machine.

### BACKGROUND

In recent years more and more providers have begun providing the ability to create computing environments in the cloud. For example, Amazon Web Services™ (also known as AWS) launched in 2006 a service that provides users with the ability to configure an entire environment tailored to an application executed over the cloud platform. In general, such services allow developing scalable applications in which computing resources are utilized to support efficient execution of the application. To this end, a programmer (a user of the cloud-computing environments) can define computing resources such as servers, web servers, routers, storage, load balancers, firewalls, backup, and connectivity as may be desired. Services for creating computing environments in the cloud allow dynamic changes to the set of computing resources and their configurations. This may include adding components or removing components from the configured environment as may be necessary, as well as changes to other configurations of the environment and changes to the configuration of each component.

Organizations and businesses that develop, provide, or otherwise maintain cloud based applications (or services) have become accustomed to relying on these services and implementing various types of environments from complex web sites to data mining process, and much more. However, there is a challenge due to greater reliance is made on such cloud-based applications or services, since computer servers executing such application should maintain a very high up-time and any failure may be highly problematic and/or costly. That is, there is a need for reliable and efficient data services to allow business continuity for businesses utilizing cloud-based applications. For example, for an e-commerce application executed in a cloud-based environment, any down time of such an application means revenue lost. As a result, providers of cloud-based applications often utilize measures to ensure continuity of operations by backing up information that is relevant to maintaining operations.

While the providers of such cloud-based environments provide various backup capabilities that automatically or semi-automatically store data from one computer (or server) in another storage space that is separate from the computer, those providers still rely on the user to address these issues effectively. Therefore, in order to ensure continuous operations of the application, mirror or backup environments are manually created by the application developer or application owner. In addition, any changes made to the primary environment must be manually updated in the backup environment.

Furthermore, such solutions may require copying massive amounts of data from the original server (machine) to a replicated machine, then attempting to initialize the replicated machine in place of the original machine. As a result, a significant down time is experienced, in addition to requiring manual modifications to account for differences between the original machine and the replicated machine. Machine replication is also useful, for example, for migrating machines from one location to another, backup purposes, staging, and so on.

In most cases, machine replication is not sufficient to enable proper operation of a cloud-based environment in the backup cloud-computing environment. Specifically, any configuration setting in the primary environment must be manually updated in the backup environment. For example, when a machine allocated in the cloud-computing environment for execution of the application includes certain firewall configuration parameters, these parameters have to be copied manually to the respective backup environment if the user or provider desires that such parameters be identical in character to those of the backed-up machine.

It would be advantageous to provide a solution to improve the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

The disclosed embodiments include a method for orchestrating replicated components in a replicated cloud-computing environment. The method comprises: receiving computer data from a first original component in a first cloud-computing environment; allocating a first replicated component in a second cloud-computing environment, the first replicated component corresponding to the first original component; initializing a loader machine in the second cloud-computing environment; replicating the computer data to the loader machine; initializing the computer data as at least a data disk of the loader machine; configuring the loader machine with a first group of attributes of the replicated computer data, the first group of attributes allowing the first replicated component to initialize a boot process in the second computing environment; providing the replicated computer data to the first replicated component; and causing initialization of a boot process of the first replicated component in the second cloud-computing environment using the first group of attributes.

The disclosed embodiments also include a system for orchestrating replicated components in a replicated cloud-computing environment. The system comprises: a processing unit; a network interface coupled to the processing unit; and a memory comprising instructions that when executed by the processing unit cause the server to: receive computer data from a first original component in a first cloud-computing environment; allocate a first replicated component in a second cloud-computing environment, the first replicated component corresponding to the first original component; initialize a loader machine in the second cloud-computing environment; replicate the computer data to the loader machine; initializing the computer data as at least a data disk of the loader machine; configure the loader machine with a first group of attributes of the replicated computer data, the first group of attributes allowing the first replicated component to initialize a boot process in the second computing environment; provide the replicated computer data to the first replicated component; and cause initialization of a boot process of the first replicated component in the second cloud-computing environment using the first group of attributes.

### BRIEF DESCRIPTION OF THE DRAWINGS

The subject matter disclosed herein is particularly pointed out and distinctly claimed in the claims at the conclusion of the specification. The foregoing and other objects, features and advantages of the invention will be apparent from the following detailed description taken in conjunction with the accompanying drawings.

FIG. 1 is a schematic illustration of a system for initializing replicated components operating within a network according to an embodiment.

FIG. 2 is a schematic illustration of an initializing system according to an embodiment.

FIG. 3 is a flowchart of a method for initializing replicated components according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality.

By way of example, a system and method thereof for initializing replicated components in a second cloud-computing environment including a loader machine are provided. In an embodiment, computer data from an original component in a first cloud-computing environment is received respective of a root disk and a boot disk. A replicated component corresponding to the original component is initialized in a second cloud-computing environment. The computer data is replicated to the loader machine and initialized as a data disk. The loader machine is configured to modify a first group of attributes of the replicated computer data, allowing the replicated component to initialize a boot process in the second cloud-computing environment. A boot process of the first replicated component is initialized and the replicated component is configured to modify a second group of attributes, which require a reboot thereafter, during the boot process, and a third group of attributes which excludes the attributes of the first and second groups.

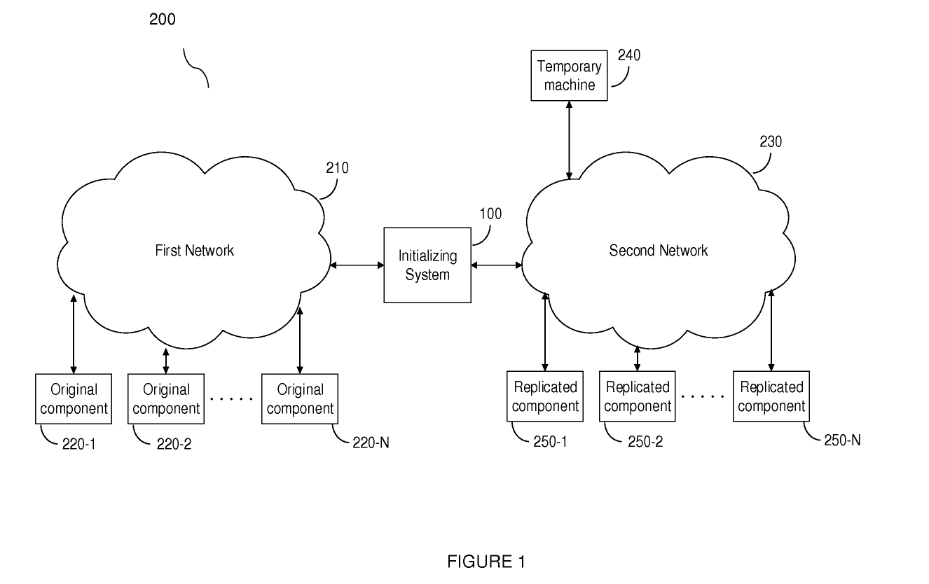

FIG. 1 is a non-limiting and exemplary schematic illustration of a cloud-computing platform 200 utilized to describe the disclosed embodiments for initializing replicated components operating within a network. As shown in FIG. 1, an orchestrating system 100 is communicatively connected with a first network 210, which provides connectivity for a first cloud-computing environment. The first network 210 is configured to provide connectivity of various sorts, as may be necessary, including, but not limited to, wired and/or wireless connectivity such as, for example, local area network (LAN) connectivity, wide area network (WAN) connectivity, metro area network (MAN) connectivity, worldwide web (WWW) connectivity, Internet connectivity, and any combination thereof, as well as cellular connectivity.

Original components 1 through N (OC₁ through OC_{N}), labeled 220-1 through 220-N (hereinafter referred to individually as an OC 220 and collectively as OCs 220, merely for simplicity purposes), are communicatively connected to the first network 210 and collectively act as the first cloud-computing environment. The first cloud-computing environment may be a public, private, or hybrid cloud-computing environment.

Any OC 220 may be a server, a physical machine, a virtual machine, one or more services, and the like. A physical machine or a virtual instance thereof may be, for example, a web server, a database server, a cache server and virtual appliances. A service may be a network architecture management service, a load balancing service, an auto scaling service, a content delivery network (CDN) service, a network addresses allocation service, database services and domain name system (DNS) services, and the like.

In an embodiment, each OC 220 further includes a root disk and a boot disk (both are not shown). A root disk may be, but is not limited to, a memory space where the root directory (e.g., of the file system) is stored. A boot disk may be a memory space where startup files are stored. The startup files are required for booting, e.g., the operating system, or a loader of the operating system, of an OC 220. In some implementations, the root disk and the boot disk are implemented on a single logical or physical disk.

The orchestrating system 100 is further communicatively connected to a second network 230 which provides connectivity for a second computing environment, in which the first computing environment may be replicated. The second network 230 is configured to provide connectivity of various sorts, as may be necessary, including but not limited to, wired and/or wireless connectivity, including, for example, LAN connectivity, WAN connectivity, WWW connectivity, Internet connectivity, and any combination thereof, as well as cellular connectivity.

Also communicatively connected to the second network 230 are a plurality of replicated components (RCs) 250-1 through 250-N (hereinafter referred to individually as an RC 250 and collectively as RCs 250), (RC₁ through RC_{N}) each correspond to an OC 220, such that RC₁ corresponds to OC₁, and generally RCᵢ to OCᵢ, where ‘N’ is a natural integer having a value of ‘1’ or greater and ‘i’ having a value of ‘1’ through ‘N’. Each RC 250 includes a root disk and a boot disk which may be realized on a single logical or physical disk.

The second network 230 is further communicatively connected to a loader machine 240. A loader machine, such as the loader machine 240, may be used to modify attributes as may be necessary for the initialization of a boot process of the replicated component. For example, the attributes including a boot sector location, kernel configurations, boot registry keys, and disk drivers may be required for initializing a boot process. A specific attribute may have a different value for each of the original component and its replicated component, thereby requiring modification. Typically, such attributes may not be possible to modify by a machine running the same disks as either root or boot disks, or otherwise requiring substantial system resources to do so. Therefore, use of the loader machine 240 allows such modifications to be made while the root and/or boot disks are initialized as data disks, and then initializing the same disks as root and/or boot disks (respectively) of the replicated component. The loader machine 240 can be realized as a physical machine or a virtual machine.

The second network 230 and the RCs 250 include the second cloud-computing environment. The second cloud-computing environment may be a public, private, or hybrid cloud-computing environment.

According to the disclosed embodiment, the orchestrating system 100 is configured to orchestrate the initialization (and execution) of any OC 220 (e.g., the OC 220-1) from the first cloud computing environment to a respective RC 250 (e.g., the RC 250-1) in the second cloud-computing environment. To this end, data residing in the root and boot disks of an OC is first replicated to the loader machine 240. As a result, the replicated data is initialized as a data disk of the loader machine 240.

In an embodiment, the replicated data includes a set of attributes required for the proper setting and initialization of the RC 250-1 in the second cloud-computing environment, thereby allowing replication of the operation of the corresponding OC 220-1. The set of attributes may be classified into a predefined number of groups such that each has its own priority.

As an example, a first group with the highest priority may include attributes which allow the RC 250-1 to execute a boot process in the second cloud-computing environment, a second group of attributes set with a medium priority includes attributes of which modification requires a reboot of the RC 250-1, and a third group of attributes with a lowest priority includes attributes which are not required for executing the boot process and do not require the replicated component to perform a reboot after modification. In an embodiment, the priority of an attributes group determines which element should modify the attributes defined in the respective group in the second cloud-computing environment. Specifically, attributes with the highest priority are modified by the loader machine 240, while lower priority attributes can be modified by the RC 250-1 (or any other RC 250).

Thereafter, the orchestrating system 100 is configured to perform a series of actions causing the initialization of the RC 250-1 in the second environment. These actions may include allocating or instantiating the RC 250-1 in the second cloud-computing environment; configuring the loader machine 240 to provide the replicated data to the RC 250-1; and configuring the loader machine 240 with the attributes that at least would allow the RC 250-1 to execute a boot process in the second cloud-computing environment. In some embodiments, the loader machine 240 is configured to check if such attributes should be modified, and causing the loader to modify one, some or all of the attributes to allow the RC 250-1 to initialize a boot process.

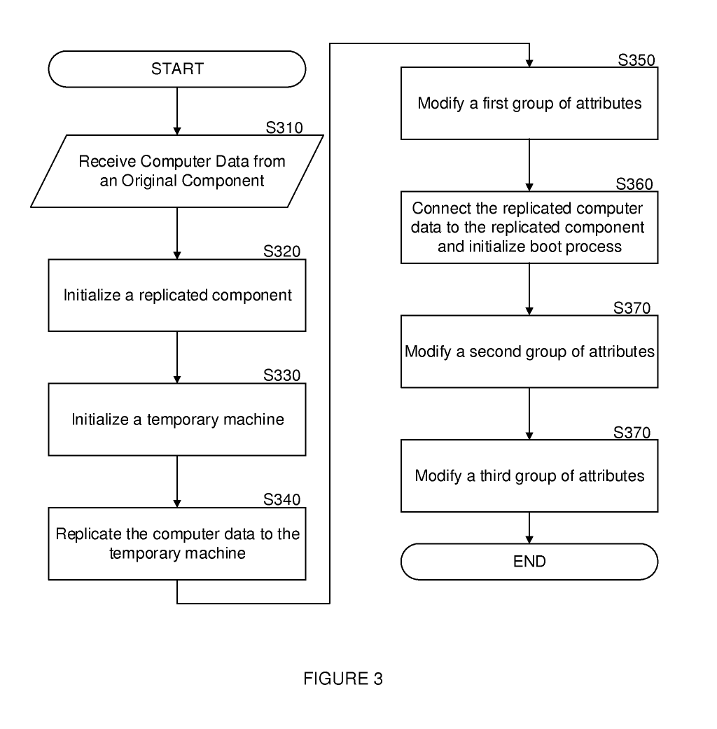

The system 110 is also configured to set the RC 250-1 with the attributes that require a reboot of the first RC 250, and optionally with attributes that are not required for initializing the boot process. In certain embodiments, the RC 250-1 is also configured to modify such attributes. Upon completion of setting and/or modifying the attributes by the RC 250-1, the RC 250-1 is ready to take over the operation of the respective OC 220-1. Operation of the orchestrating system 100 is described further herein below with respect to FIG. 3.

It should be noted that, in certain embodiments, the loader machine 240 may serve as the RC 250-1 or any replicated component (RC) selected to backup an original component (OC). The attributes described herein may be stored on a root disk, a boot disk, or a combination thereof.

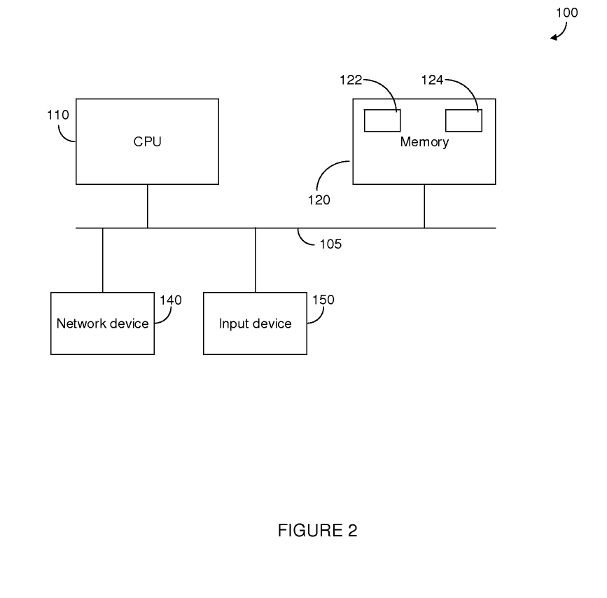

FIG. 2 is an exemplary and non-limiting schematic illustration of the orchestrating system 100 for initializing replicated machines according to an embodiment. The system 100 includes at least one processing element 110. In an embodiment, the processing unit 110 may comprise, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing element 110 is coupled via a bus 105 to a memory 120. The memory 120 further comprises a memory portion 122 that contains instructions that, when executed by the processing element 110, configures the orchestrating system 100 to perform the disclosed embodiments. The memory may be further used as a working scratch pad for the processing element 110, a temporary storage, and so on.

The memory 120 may comprise a volatile memory such as, but not limited to, random access memory (RAM), or non-volatile memory (NVM), such as, but not limited to, Flash memory. The memory 120 may further comprise a memory portion 124 containing the various attributes discussed in further detail herein above.

In certain configurations, the processing element 110 may be coupled, via the bus 105, to an input 150 and a network card 140, for providing connectivity between the orchestrating system 100 and a network, such as the first network 210 as discussed in more detail with respect to FIG. 1.

The processing unit 110 and/or the memory 120 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein.

FIG. 3 is a non-limiting and exemplary flowchart 300 of a method for initializing replicated components according to an embodiment.

In S310, computer data is received from a first original component (e.g., the OC₁ 220-1). Computer data includes a root disk and a boot disk of the first original component. As noted above, the root disk and boot disk of the original component may be implemented on a single physical or logical disk.

In S320, a first replicated component (e.g., the RC 250-1) is allocated or instantiated in the second cloud-computing environment corresponding to the first original component.

In S330, a loader machine (e.g., the loader machine 240) is initialized in the second cloud-computing environment.

In S340, the computer data is replicated to the loader machine. The root disk and the boot disk are then initialized as a data disk of the loader machine. As discussed in further detail herein above, this initialization of the root and boot disks as a data disk of the loader machine allows for optimized modification, overwriting, and other alterations to attributes and/or content of the root disk and boot disk. In some embodiments, either a root disk or a boot disk may be attached as a data disk of the loader machine. It can be appreciated that multiple root disks and/or multiple boot disks can be utilized without departing from the scope of this disclosure.

In S350 the loader machine is configured with a first group of attributes of the replicated computer data. The first group includes attributes that allow the replicated component to initialize a boot process in the second cloud-computing environment. Such an attribute may be, for example, the location of the boot sector.

According to an embodiment, S350 further includes checking if the first group of attributes should be modified by the loader machine and, if so, configuring the loader machine to modify one, some, or all of the attributes contained in the first group. The modification of attributes in the first group is required for the proper initialization of the replicated machine in the second cloud-computing environment.

As a non-limiting example, a machine with a disk space of 500 Gb is replicated to a cloud-computing environment. Although the replicated hard disk may have the same storage capacity as the original hard disk, the replicated hard disk may require completely different drivers to run, have a different boot sector location, and so on. Thus, if the data on the original hard disk is replicated to the replicated hard disk, the replicated components may not boot properly since it would be unable to initialize the replicated hard disk. To accommodate the replicated hard disk, the drivers and boot sector location are modified to support initialization of the first replicated component in the second cloud-computing environment.

In S360, the replicated computer data is provided to the first replicated component. In an embodiment, the replicated computer data is saved in a cloud storage (disk) in the first cloud-computing environment such that the replicated hard disk can be communicatively connected to the loader machine. That is, in an embodiment, the loader machine is configured to access or connect to the disk or storage containing the replicated computer data.

A boot process is then initialized for the first replicated component. In some embodiments, the loader machine may be terminated at this point or may be used to modify additional disks for other original components. In certain embodiments, the loader machine may be used to modify a plurality of disks for a plurality of original components in parallel to each other.

In S370, the first replicated component is configured with a second group of attributes of the replicated computer data during the boot process. In an embodiment, the second group of attributes includes attributes, the modification of which requires a reboot of the first replicated component. For example, configuring a network card driver may not be typically necessary for initializing a boot process, but may be necessary to successfully complete it. Therefore, the network card driver may be configured during the boot process, which would require the replicated component to reboot thereafter.

In S380, the first replicated component is configured with a third group of attributes of the replicated computer data. In an embodiment, the third group includes attributes which are not required for initializing the boot process and do not require the replicated component to perform a reboot after modification. Typically, the third group of attributes excludes the attributes of the first group and the second group for the run time of the replicated component. These attributes are not critical for the boot process to successfully complete, and do not require a reboot of the replicated component after they are modified. For example, setting a machine's clock does not require a reboot and is not critical for a successful boot.

According to one embodiment, S370 and S380 may further include checking if the second group and/or third group of attributes should be modified by the loader machine. If so, the first replicated component is configured to modify any or all of the attributes contained in the second and/or third group. The modification of attributes in the first group is required for the proper initialization of the replicated machine in the second cloud-computing environment. In an embodiment, modifying the attributes in the second or third group is performed by injecting a script to the first replicated component causing for such modification.

It should be readily appreciated that an attribute may be in one group during a first run of a replicated component, and in a second group during a second run of the replicated component. For example, an attribute may be in the second group when replicating an original machine to a replicated component in a first computing environment. The same attribute may be in the third group when replicating the replicated component from the first computing environment to a secondary replicated component in a second computing environment. It should be further appreciated that method can be equally performed with a different number of attributes groups. That is, the number of attributes is not limited to three and can be less or more than three without departing from the scope of the disclosed embodiments. Further examples of attributes may include, but are not limited to, boot sector location, bootloader location, partition table, registry key, registry value, configuration file, physical hardware driver, virtual hardware driver, installed software, disk geometry, and operating system kernel.

The various embodiments have been discussed herein with a specific reference where the loader machine is utilized as a temporary machine for the first replicated component. However, in certain embodiments, the loader machine and the first replicated component are the same machine. That is, the replicated computer data is provided directly to the first replicated component; which is configured to modify the attributes as discussed in detail above.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for orchestrating replicated components in a replicated cloud-computing environment, comprising:
receiving computer data from a first original component in a first cloud-computing environment;
allocating a first replicated component in a second cloud-computing environment, the first replicated component corresponding to the first original component;
initializing a loader machine in the second cloud-computing environment;
replicating the computer data to the loader machine;
initializing the computer data as at least a data disk of the loader machine;
configuring the loader machine with a first group of attributes of the replicated computer data, the first group of attributes allowing the first replicated component to initialize a boot process in the second computing environment;
providing the replicated computer data including the first group of attributes to the first replicated component; and
causing initialization of a boot process of the first replicated component in the second cloud-computing environment using the first group of attributes.

2. The method of claim 1, wherein configuring the loader machine with the first group of attributes further comprises:
checking, for each attribute in the first group of attributes, if the attribute requires modification to allow proper execution of the boot process; and
configuring the loader machine to modify each attribute in the first group of attributes that requires modification.

3. The method of claim 1, further comprising:
configuring the first replicated component with a second group of attributes of the replicated computer data during the boot process.

4. The method of claim 3, wherein configuring the first replicated component with the second group of attributes further comprises:
checking, for each attribute in the second group of attributes, if the attribute requires modification; and
configuring the first replicated component to modify each attribute in the second group of attributes that requires modification, wherein the modification of attributes in the second group of attributes requires a reboot of the first replicated component.

5. The method of claim 4, wherein configuring the first replicated component to modify the second group of attributes further comprises:
injecting the first replicated component with a script; and
causing the first replicated component to modify the second group of attributes based on the script.

6. The method of claim 2, further comprising:
configuring the first replicated component with a third group of attributes of the replicated computer data.

7. The method of claim 6, wherein configuring the first replicated component with the third group of attributes further comprises:
checking, for each attribute in the third group of attributes, if the attribute requires modification, wherein the third group of attributes excludes the attributes of the first group and of the second group; and
configuring the first replicated component to modify each attribute in the third group of attributes that requires modification.

8. The method of claim 1, wherein the computer data includes at least one of a root disk and a boot disk, wherein the root disk and the boot disk are any of: a single physical disk, and a single logical disk.

9. The method of claim 1, wherein the first group of attributes includes at least one of: a boot sector location, a bootloader location, a partition table, a registry key, a registry value, a configuration file, a physical hardware driver, a virtual hardware driver, installed software, disk geometry, and an operating system kernel.

10. The method of claim 3, wherein the second group of attributes comprises at least one of: a boot sector location, a bootloader location, a partition table, a registry key, a registry value, a configuration file, a physical hardware driver, a virtual hardware driver, installed software, disk geometry, and an operating system kernel.

11. The method of claim 6, wherein the third group of attributes comprises at least one of: a boot sector location, a bootloader location, a partition table, a registry key, a registry value, a configuration file, a physical hardware driver, a virtual hardware driver, installed software, disk geometry, and an operating system kernel.

12. The method of claim 1, wherein the first cloud-computing environment and the second cloud-computing environment are within a single cloud-computing environment.

13. A non-transitory computer readable medium having stored thereon instructions for causing one or more processing units to execute the method according to claim 1.

14. A system for orchestrating replicated components in a replicated cloud-computing environment comprising:
a processing unit;
a network interface coupled to the processing unit; and
a memory comprising instructions that when executed by the processing unit cause the server to:
receive computer data from a first original component in a first cloud-computing environment;
allocate a first replicated component in a second cloud-computing environment, the first replicated component corresponding to the first original component;
initialize a loader machine in the second cloud-computing environment;
replicate the computer data to the loader machine;
and initializing the computer data as at least a data disk of the loader machine;
configure the loader machine with a first group of attributes of the replicated computer data, the first group of attributes allowing the first replicated component to initialize a boot process in the second computing environment;
provide the replicated computer data including the first group of attributes to the first replicated component; and
cause initialization of a boot process of the first replicated component in the second cloud-computing environment using the first group of attributes.

15. The system of claim 14, wherein the system is further configured to:
check, for each attribute in the first group of attributes, if the attribute requires modification to allow proper execution of the boot process; and
configure the loader machine to modify each attribute in the first group of attributes that requires modification.

16. The system of claim 14, wherein the system is further configured to:
configure the first replicated component with a second group of attributes of the replicated computer data during the boot process.

17. The system of claim 16, wherein the system is further configured to:
check, for each attribute in the second group of attributes, if the attributes in the second group of attribute requires modification; and
configure the first replicated component to modify each attribute that requires modification, wherein the modification of attributes in the second group of attributes requires a reboot of the first replicated component.

18. The system of claim 17, wherein the system is further configured to:
inject the first replicated component with a script; and
cause the first replicated component to modify the second group of attributes based on the script.

19. The system of claim 15, wherein the system is further configured to:
configure the first replicated component with a third group of attributes of the replicated computer data.

20. The system of claim 19, wherein the system is further configured to:
check, for each attribute in the third group of attributes, if the attribute requires modification, wherein the third group of attributes excludes the attributes of the first group and of the second group; and
configure the first replicated component to modify each attribute in the third group of attributes that requires modification.

21. The system of claim 14, wherein the computer data includes at least one of a root disk and a boot disk, wherein the root disk and the boot disk are any of: a single physical disk, and a single logical disk.

22. The system of claim 14, wherein the first group of attributes includes at least one of: a boot sector location, a bootloader location, a partition table, a registry key, a registry value, a configuration file, a physical hardware driver, a virtual hardware driver, installed software, disk geometry, and an operating system kernel.

23. The system of claim 16, wherein the second group of attributes comprises at least one of: a boot sector location, a bootloader location, a partition table, a registry key, a registry value, a configuration file, a physical hardware driver, a virtual hardware driver, installed software, disk geometry, and an operating system kernel.

24. The system of claim 19, wherein the third group of attributes comprises at least one of: a boot sector location, a bootloader location, a partition table, a registry key, a registry value, a configuration file, a physical hardware driver, a virtual hardware driver, installed software, disk geometry, and an operating system kernel.

25. The system of claim 14, wherein the first cloud-computing environment and the second cloud-computing environment are within a single cloud-computing environment.
